(19) United States
(12) Patent Application Publication
(10) Pub. No.: US 2012/0311480 A1
(43) Pub. Date: Dec. 6, 2012

(54) TYPE AND SELECT DATA INPUT FIELD

(76) Inventor: Michael Cohen, Den Haag (NL)

(21) Appl. No.: 13/578,408

(22) PCT Filed: Jan. 24, 2011
(86) PCT No.: PCT/EP11/50892

§ 371 Date: Aug. 10, 2012

(30) Foreign Application Priority Data
Feb. 12, 2010 (EP) 10153468.3

(51) Int. Cl. G06F 3/048

(52) U.S. Cl. 715/780

(57) ABSTRACT

A method is provided for selecting a string (52, 82, 97, 125) from a large amount of selectable strings. The method comprises providing a graphical representation of a data entry field (20, 90), receiving at least one input character (33, 43, 53) entered by a user, based on the at least one input character (33, 43, 53) selecting a plurality of relevant strings from the large amount of selectable strings, and displaying a suggestions list (31, 41, 51, 61, 81, 88, 91, 124) comprising the plurality of relevant strings (32, 42, 52). The method is characterized in that each relevant string (32, 42, 52) in the displayed suggestions list (31, 41, 51) is provided with at least one corresponding list ordering character (3, 4, 5, 7), and in that the string (52, 82, 97, 125) is selected from the suggestions list (51, 61, 81, 91, 124) by the user entering the corresponding list ordering character (5, 7).

### FIELD OF THE INVENTION

This invention relates to a method of selecting a string from a large amount of selectable strings, the method comprising providing a graphical representation of a data entry field, receiving at least one input character entered by a user, based on the at least one input character selecting a plurality of relevant strings from the large amount of selectable strings, and displaying a suggestions list comprising the plurality of relevant strings.

This invention further relates to a computer program product for performing such a method.

### BACKGROUND OF THE INVENTION

In present day user interfaces, it is known to provide a data input field which is programmed to provide one or more suggestions for completing a string that has already been entered partially by a user. For example in OpenOffice, a word processor is provided using some algorithm to ‘guess’ what word a user is typing. After typing one or more characters the program adds the remaining characters of the suggested word in a highlighted manner. The user may then select the suggested word by pressing the spacebar or the return key or may continue entering characters. When an additional character is entered, a new suggestion may be generated and presented. Similar auto-completion features are available in other word processors and text editors. For example, many SMS editors for mobile phones use such auto-completion. A disadvantage of this type of auto-completion is that only one suggestion is provided, thereby reducing the chance of offering a suggestion that will actually be selected by the user.

A solution for providing multiple suggestions to the user is, e.g., known from Google.com. When entering a character in the search input field on the search input field at the Google.com homepage, a list with then frequently used search terms starting with said character is displayed. For each additional character being entered, the list with suggestions is updated. The user may select one of the suggested search terms by clicking on it with a mouse pointer. Selection of a suggestion from the list may alternatively be realized by going through the list with the arrow keys, followed by selecting one of the suggestions using the space bar (allowing the user to enter additional characters) or pressing the return key (immediately performing a search based on the selected string). Although this suggestions list increases the chance of providing a suggestion that might be useful, selecting one of the suggested strings requires the user to perform multiple actions. Consequently selecting a suggestion from the list may not be much easier than just typing the complete string.

### OBJECT OF THE INVENTION

It is an object of the invention to provide an auto-completion feature offering multiple suggestions and providing an easier way of selecting one of the suggestions.

### SUMMARY OF THE INVENTION

According to a first aspect of the invention, this object is achieved by providing a method of selecting a string from a large amount of selectable strings, the method comprising providing a graphical representation of a data entry field, receiving at least one input character entered by a user, based on the at least one input character selecting a plurality of relevant strings from the large amount of selectable strings, displaying a suggestions list comprising the plurality of relevant strings, each relevant string in the displayed suggestions list being provided with at least one corresponding list ordering character, and the string being selected from the suggestions list by the user entering the corresponding list ordering character.

In this way, selecting one of the suggested strings is performed using only one key stroke, which is considerably easier than taking a mouse to select one of the options or using multiple arrow keys to select the correct suggestion. The selected string may, e.g., be an input for a search query, a contact to whom an e-mail should be sent or a phone call made, or just a word in a written text. The selection of one of the suggestions may either involve highlighting only or also performing the corresponding action (searching, making phone call, writing e-mail, etc.). The suggestions may be generated using algorithms known in the art. The already entered characters may be used as a filter for finding relevant strings in the large amount of selectable strings. A string may, e.g., be considered relevant because it starts with or comprises the same characters or a similar combination of characters as already entered.

It is important that each suggested string is accompanied by a corresponding and unique list ordering character. The corresponding list ordering characters may comprise letters and/or numbers. If the data entry field is provided for entering text (e.g. contact names or search strings), it might be preferable to use numbers as list ordering characters. If the data entry field is to be filled with numbers, it would be better to use letters as list ordering characters. It is also possible to use a combination of letters and numbers or labels representing the function keys (F1, F2, F3, . . . ). When numbers are used, these numbers may either be one digit numbers (0 to 9) or multiple digit numbers (10+). Suggestion ‘11’ may, e.g., be selected by entering ‘1’ and ‘1’. When entering the first ‘1’, suggestion ‘1’ is highlighted. When entering the second ‘1’, suggestion ‘11’ is highlighted.

Also when the list ordering characters are numbers, it might be desirable to use numbers as (part of) the input string for the data entry field. In order to distinguish the selection of one of the suggested strings from just typing a number as part of the string to be entered, selection of a suggested string may be realized by combining the corresponding with one or more other keys in a short key combination. For example, option ‘4’ may be selected by pressing ‘Ctrl-4’, ‘Alt-4’ or ‘Ctrl-Shift-4’. For this purpose, also the use of the function keys (F1, F2, . . . ) is very convenient.

These and other aspects of the invention are apparent from and will be elucidated with reference to the embodiments described hereinafter.

### BRIEF DESCRIPTION OF THE DRAWINGS

In the drawings:

FIG. 1 shows a flow diagram of a method according to the invention,

FIG. 2a shows a data entry field to which the current invention may be applied,

FIG. 2b shows a data entry field which, upon activation, provides a suggestions list,

FIG. 3 shows the data entry field after entering one character,

FIG. 4 shows the data entry field after entering a second character,

FIG. 5 illustrates selection of a suggested string,

FIG. 6 shows how numbers may be used for both data entry and suggestion selection,

FIG. 7 shows an alternative way of allowing numbers to be used as data entry,

FIG. 8a illustrates suggesting a string comprising at least one number,

FIG. 8b shows a data entry not resulting in any suggestion,

FIG. 9 shows a search input field,

FIGS. 10a and 10b show the search input field with a suggestions list according to the invention,

FIG. 11 illustrates selecting a suggested string for performing a search query, and

FIGS. 12 and 13 show the method according to the invention applied to a text editor.

### DETAILED DESCRIPTION OF THE INVENTION

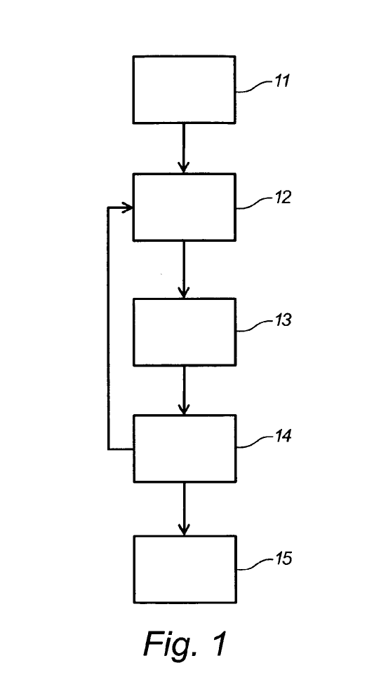

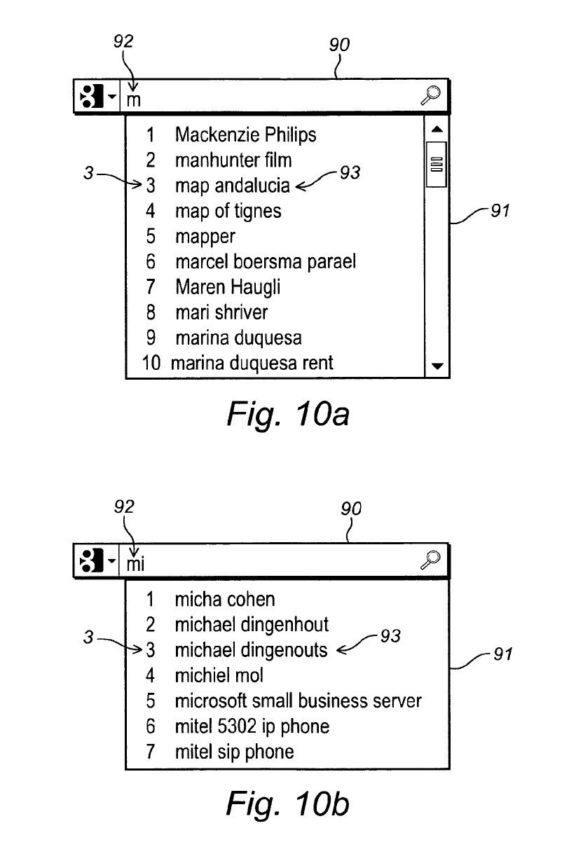

FIG. 1 shows a flow diagram of a method according to the invention. The method starts with providing a user interface with a data entry field (step 11). The user may select the data entry field and enter a first character (step 12), serving as input for the method according to the invention. Based on the entered character, a plurality of relevant strings is selected (step 13). Many algorithms are known for determining the relevance of a string based on one or more characters. A string may, e.g., be considered relevant because it starts with or comprises the entered character and/or because it was recently used. Suggestions providing step 14 is an important step in the current invention. In suggestions providing step 14 a list with relevant strings is displayed to enable the user to select a string from the list. As will be elucidated below with reference to FIGS. 10-13, the suggested strings are accompanied by corresponding ordering characters in the form of numbers. Each suggested string has its own reference number. For every additional character entered by the user (step 12), the determining of relevant strings (step 13) and displaying of a list with suggested strings and corresponding numbers (step 14) are repeated. In a selection step 15, the user selects one of the suggested strings from the list. This may be done like in the prior art, using a mouse or other pointer device, or using arrow keys on a keyboard. However, the selection is preferably performed by typing the ordering character corresponding to the suggested string to be selected. Some embodiments of this method are provided below.

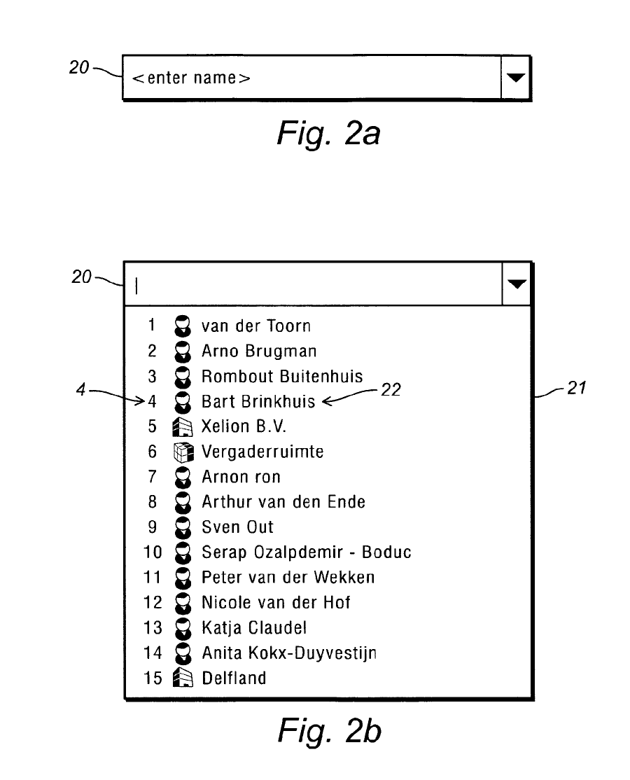

FIG. 2a shows a data entry field 20 to which the current invention may be applied. In the example described below, the data entry field 20 is used in an application for organizing and employing contact information. Data entered into the data entry field 20 may, for example, be used for selecting a contact to make a phone call to or to send an e-mail. The contact may also be selected to enable editing the corresponding contact details.

FIG. 2b shows the data entry field 20 after activation. The data entry field may, e.g., be activated by clicking on it using a pointer device or other type of pointing device or by using the tab key or a short key. After activation, the data entry field 20 may already provide a suggestions list 21. In this example, the suggestions list 21 shows 15 recently used contacts. Alternatively, the suggestions list 21 may show show the first 15 contacts (alphabetically arranged) or a random set of contacts. It is also possible not to show any suggestions at all before data is entered by the user. All suggested strings 22 on the list 21 are preceded by a unique number 4. As will be elucidated below, the user may select one of the suggested strings 22 by entering the corresponding number 4.

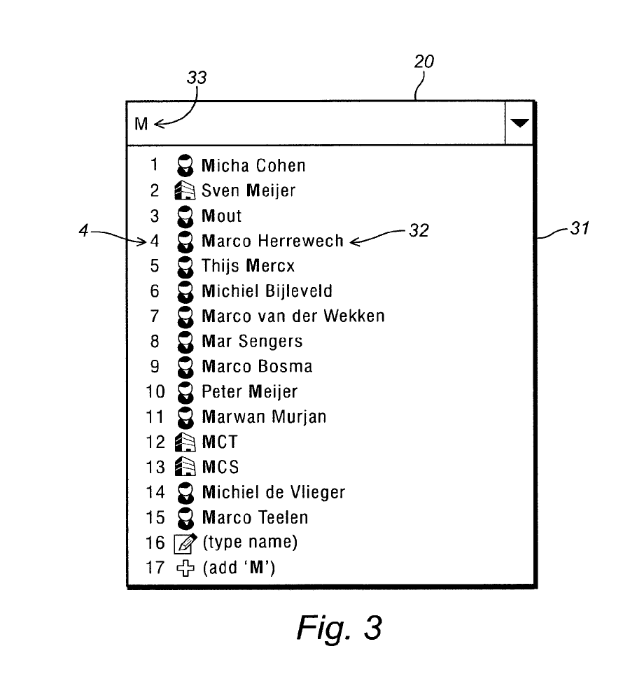

FIG. 3 shows the data entry field 20 after entering one character 33. In this example the user has entered an ‘M’ 33. As a result a plurality of contacts 32 is selected of which the first name and/or the last name starts with an ‘M’. Alternatively, contacts 32 may be selected when the first and/or last name comprise an ‘M’ or ‘m’. Preferably the latter option is only used when the amount of names starting with an ‘M’ is too small. Filtering and ordering the suggested contacts 32 may additionally be done alphabetically or based on frequency of use or moment of last use.

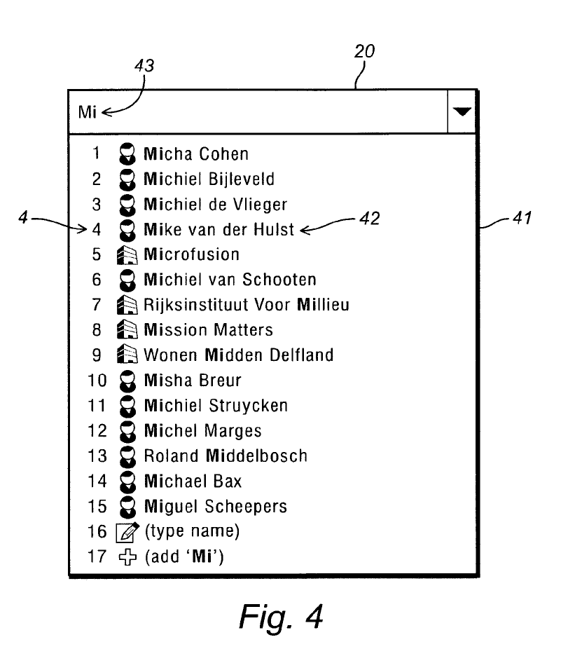

FIG. 4 shows the data entry field 20 after having entered two characters 43. The list with suggestions 41 now comprises all contacts 42 having a name (first, middle or last name) starting with ‘Mi’ 43. When comparing the suggestions lists 21, 31, 41 of FIGS. 2, 3 and 4, it is clear that the same reference number 4 may correspond to different contacts 22, 32, 42. For every character entered in the data entry field 20, the suggestion list 41 is updated.

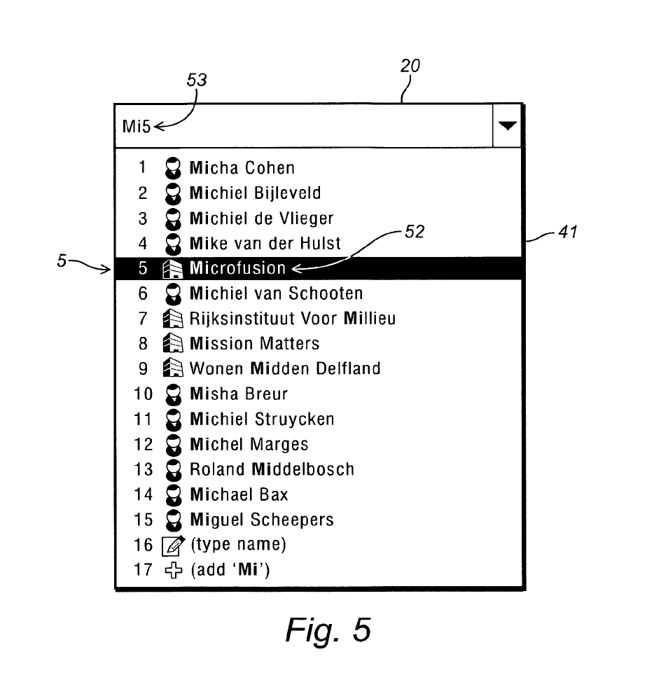

FIG. 5 illustrates selection of a suggested contact 52 from the suggestions list 41. The situation of FIG. 5 is obtained when, in the situation described for FIG. 4, the user enters the number ‘5’. Reference number ‘5’ corresponds to the contact ‘Microfusion’ 52. When the user enters the number ‘5’, this contact 52 is selected. In this figure, the selecting has resulted in highlighting of the corresponding contact 52. Then, this highlighted contact 52 may be used for performing a contact related action, such as sending an e-mail, making a phone call, listing appointments with this contact, editing the contact details, looking for messages sent by this contact, etc. These operations may be performed in direct response to the user selecting the contact 52 when entering the number ‘5’. Alternatively, the selection comprises two separate steps: one step of activating/highlighting the contact 52 and one step of performing an action using this contact 52. The latter step may, e.g., be initiated by pressing the return key when the contact 52 is highlighted.

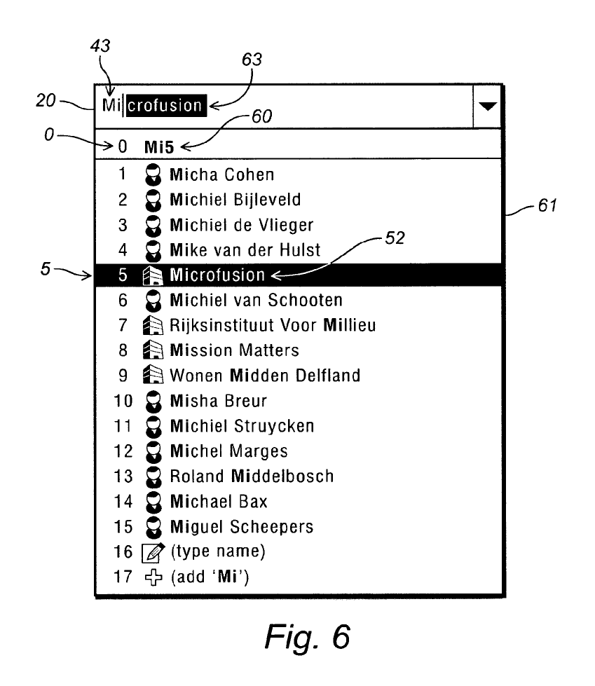

FIG. 6 shows how numbers may be used for both data entry and suggestion selection. Also FIG. 6 shows what may happen when, starting from the situation of FIG. 4, entering the number ‘5’. As described above with reference to FIG. 5, the number ‘5’ corresponds to one of the suggested contacts 52. In this example, the entering of the number ‘5’ leads to the completion of the input string 43 by adding the remaining characters 63 of the contact name 52. The remaining characters 63 are provided in a highlighted fashion, such that a subsequently entered character of the input string 43 will overwrite the remaining characters 63.

It is however a problem that also contacts or other strings for which the data entry field 20 is used may comprise numbers. For a computer program, it may not be possible to know whether the user enters the number ‘5’ in order to select one of the contacts 52 or in order to look for a contact comprising a ‘5’ in its name. In this example, this problem is solved by adding a selection option 60 to the suggestions list. This added selection option 60 is, by example, preceded by the reference number ‘0’. When the user would enter a ‘0’, the string ‘Mi5’ is put into the data entry field 20 and the user is allowed to continue entering input data. Alternatively, entering a ‘5’ again might result in replacing the highlighted part 63 of the string in the data entry field 20 by a character ‘5’, resulting in the string ‘Mi5’.

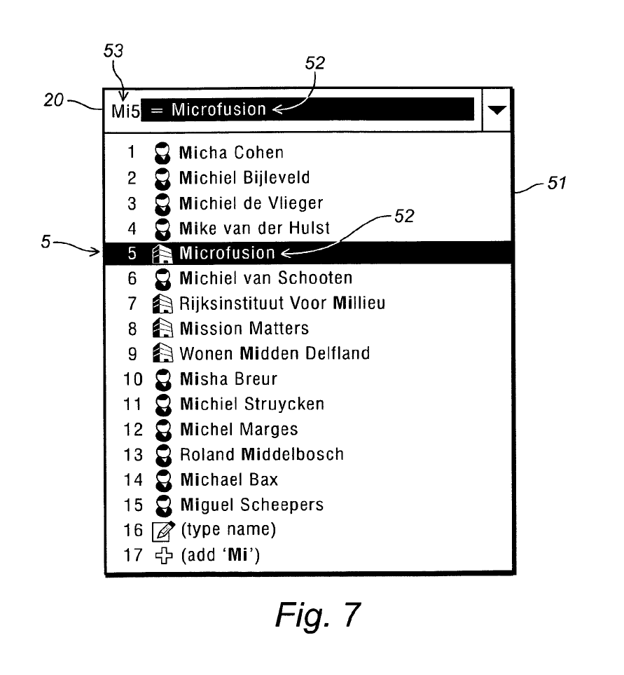

FIG. 7 shows an alternative way of allowing numbers to be used as data entry. Here both the entered input string ‘Mi5’ 53 and the selected contact suggestion ‘Microfusion’ 52 are displayed. When the user presses the return key or another key for initiation action, the selected contact suggestion 52 may be used, e.g., for sending an e-mail to. When the user continues typing, that may be interpreted as the user not being interested in the selection of ‘Micro fusion’. The highlighted suggestion 52 may then be deleted.

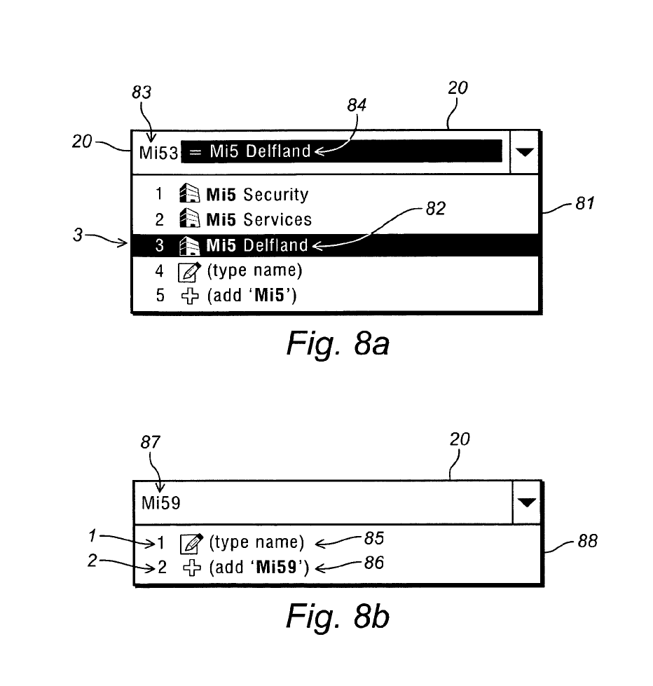

FIG. 8a illustrates suggesting a string comprising at least one number. Here multiple strings comprising ‘Mi5’ are available for selection. Entering the characters ‘Mi5’ leads to the list 81 with suggestions as shown in FIG. 8a. The third option 82 may be selected by entering the corresponding number ‘3’.

FIG. 8b shows a data entry not resulting in any suggestion. Here, the user has entered the string ‘Mi59’ 87. No relevant contacts are available for selection. The user is now presented with an option 85 to use a name that is not on the list of available contacts and with an option 86 to add a new contact with the name ‘Mi59’ to the available contacts. The options may be selected by entering, behind the string 87, the reference numbers ‘1’ or ‘2’ corresponding to the respective options 85, 86.

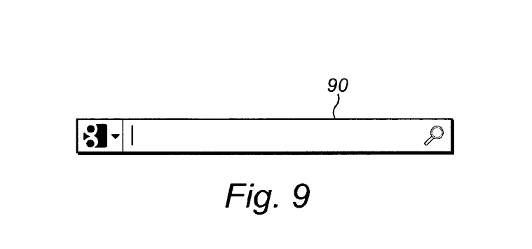

FIG. 9 shows a search input field 90. This search input field may be used on a website for searching the internet, such as google.com or in any other software application with an option to search for items using search strings.

FIGS. 10a and 10b show the search input field with a suggestions list 91 according to the invention. Search strings are selected in a way similar to the selection of contacts described above. A user enters characters 92 in the search input field 90. A suggestions list 91 with relevant search terms is provided and a search term 93 from the list 91 may be selected by entering the corresponding number 3.

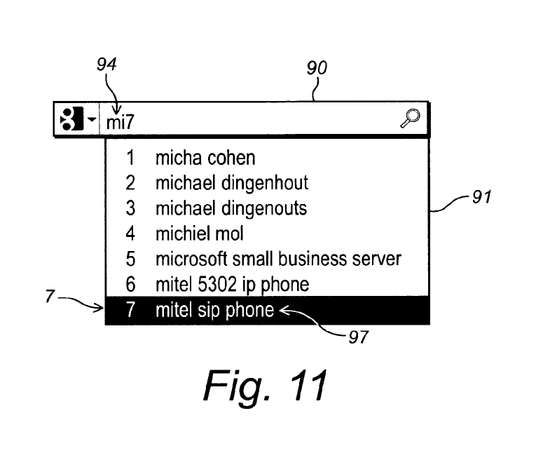

FIG. 11 illustrates selecting a suggested string for performing a search query. Here, the option 97 corresponding to reference number 7 is selected.

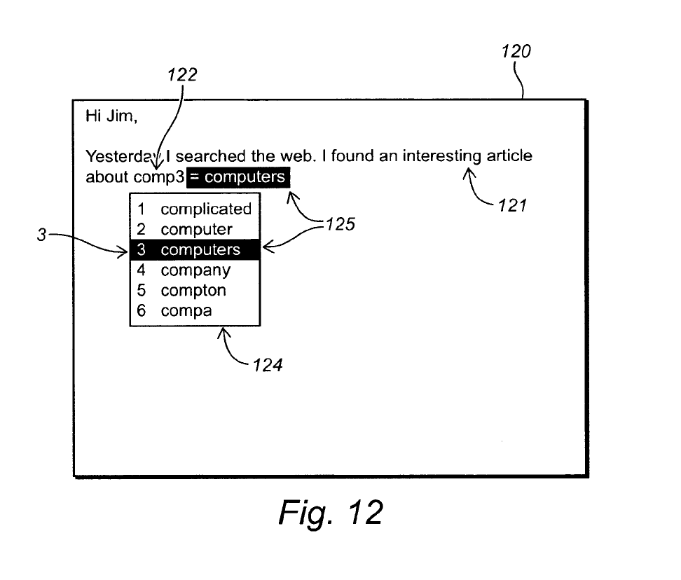

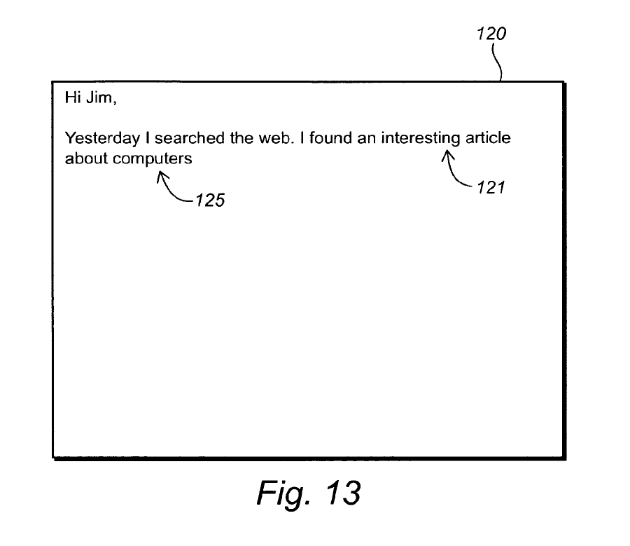

FIGS. 12 and 13 show the method according to the invention applied to a text editor 120. While typing text 121, a suggestions list 124 is presented for completing the word starting with an already entered substring ‘comp’ 122. The user may now complete the word ‘computers’ by typing the missing characters ‘uters’ or, according to the invention by only typing a number ‘3’ which corresponds to the suggestion ‘computers’ 125 from the suggestions list 124. In FIG. 13 the text is shown after the user has selected the word ‘computers’ 125 from the list 124.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. It will also be appreciated that such a program may have many different architectural designs. For example, a program code implementing the functionality of the method or system according to the invention may be subdivided into one or more subroutines. Many different ways to distribute the functionality among these subroutines will be apparent to the skilled person. The subroutines may be stored together in one executable file to form a self-contained program. Such an executable file may comprise computer executable instructions, for example processor instructions and/or interpreter instructions (e.g. Java interpreter instructions). Alternatively, one or more or all of the subroutines may be stored in at least one external library file and linked with a main program either statically or dynamically, e.g. at run-time. The main program contains at least one call to at least one of the subroutines. Also, the subroutines may comprise function calls to each other. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth. These instructions may be subdivided into subroutines and/or be stored in one or more files that may be linked statically or dynamically.

The carrier of a computer program may be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal, which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A method of selecting a string (52, 82, 97, 125) from a large amount of selectable strings, the method comprising:
providing a graphical representation of a data entry field (20, 90),
receiving at least one input character (33, 43, 53) entered by a user,
based on the at least one input character (33, 43, 53) selecting a plurality of relevant strings from the large amount of selectable strings, and
displaying a suggestions list (31, 41, 51, 61, 81, 88, 91, 124) comprising the plurality of relevant strings, characterized in that
each relevant string (32, 42, 52) in the displayed suggestions list (31, 41, 51) is provided with at least one corresponding list ordering character (3, 4, 5, 7), and in that the string (52, 82, 97, 125) is selected from the suggestions list (51, 61, 81, 91, 124) by the user entering the corresponding list ordering character (5, 7).

2. A method of selecting a string (52, 82, 97, 125) from a large amount of selectable strings as claimed in claim 1, wherein the at least one list ordering character comprises a number (4, 5).

3. A method of selecting a string (52, 82, 97, 125) from a large amount of selectable strings as claimed in claim 1, wherein the at least one list ordering character comprises a letter.

4. A method of selecting a string (52, 82, 97, 125) from a large amount of selectable strings as claimed in claim 1, further comprising displaying the selected string (52, 82, 97, 125) in the data entry field.

5. A method of selecting a string (52, 82, 97, 125) from a large amount of selectable strings as claimed in claim 1, further comprising displaying the at least one input character (33, 43, 53) and the entered corresponding list ordering character (5) in the data entry field (20, 90) and highlighting the selected string (52) in the suggestions list (51).

6. A method of selecting a string (52, 82, 97, 125) from a large amount of selectable strings as claimed in claim 1, further comprising displaying the at least one input character (33, 43, 53), the entered corresponding list ordering character (5) and the selected string(52, 82, 97, 125) in the data entry field (20, 90).

7. A method of selecting a string (52, 82, 97, 125) from a large amount of selectable strings as claimed in claim 1, wherein the string (52, 82, 97, 125) is selected from the suggestions list (31, 41, 51, 61, 81, 88, 91, 124) by the user activating a short key combination comprising the corresponding list ordering character (3, 4, 5).

8. A method of selecting a string (52, 82, 97, 125) from a large amount of selectable strings as claimed in claim 1, wherein the data entry field (20, 90) is a search input field (90) and wherein the selected string is used for generating a search query.

9. A computer program product for selecting a string, which program is operative to cause a processor to perform the method as claimed in claim 1.
